(19) United States
(12) Patent Application Publication
(10) Pub. No.: US 2006/0031708 A1
(43) Pub. Date: Feb. 9, 2006

(54) Method and apparatus for correcting errors in a cache array

(76) Inventor: Kiran R. Desai, Cupertino, CA (US)

Correspondence Address: KENYON & KENYON, 1500 K STREET NW, SUITE 700, WASHINGTON, DC, 20005, US

(21) Appl. No.: 10/910,337

(22) Filed: Aug. 4, 2004

(51) Int. Cl. G06F 11/00; G06F 12/00

(52) U.S. Cl. 714/5; 711/122; 711/146

(57) ABSTRACT

A system and method is provided for correcting errors in a cache array. Embodiments may include a lower level cache tag array to store a plurality of lower level tags to identify a location in a lower level cache of a requested data, an error detection element to detect that one of the lower level tags stored in the lower level tag array has an error, an upper level cache tag array to store a plurality of upper level tags to identify a location in an upper level cache of the requested data if the lower level tags do not identify a location of the requested data in the lower level cache, and an error handler to derive a correct value for the stored lower level tag that has an error from one of the upper level tags stored in the upper level tag array.

### TECHNICAL FIELD

Embodiments of the present invention generally relate to methods and apparatus for correcting errors in information stored in a cache memory array.

### BACKGROUND OF THE INVENTION

Computerized systems typically employ a hierarchy of memory devices to store information, such as a system memory and one or more cache memories. A cache memory (or “cache”) is device that may be used to store frequently used data values for quick access. In a typical system, a processing engine might first request data from a lower level cache, which will either return the data requested (if that cache has stored a copy of that data) or forward the request to an upper level cache, which may either return the data requested (if the upper level cache has stored a copy of that data) or forward the request to a system memory. Such a cache hierarchy may include any number of caches. In some systems, the lowest cache in the hierarchy (i.e., the one closest to the processing engine) may be referred to as the level one or “L1” cache and may be part of the same integrated circuit chip as the processing engine. In addition, an individual cache may be used by multiple processing engines.

An individual cache memory may include a plurality of memory arrays such as a “data array,” which stores the information or “data” that is being cached, and a “tag array,” which contains tags that may be used to identify which location or “line” in the data array stores the information being cached. In a typical arrangement, the processing engine may send to a cache a request for data identified by a system memory address, and the cache may view this address as a having a “set” portion and a “tag” portion. As is well known, the set portion may be used to identify a group of entries in a tag array and the tag portion may then be compared against these tag array entries to determine if and where there is a match, thereby identifying whether a particular way in the cache stores the information corresponding to a particular system memory address. Many caches also store information relating to the coherence of the data stored. Where the “MESI” cache coherence protocol is employed, for example, the cache records whether lines of data stored in the data array are in one of the Modified (“M”), Exclusive (“E”), Shared (“S”), or Invalid (“I”) states. Caches may also use a different protocol or a variation of the MESI protocol. For example, in one variation an additional “P” state indicates that an update is pending for this cache line.

Many caches contain error protection and detection bits for the cache tag arrays. For example, such cache tag arrays may use parity protection or Single-Error Correction and Double-Error Detection (SECDED). In a parity protected tag array, if a stored tag has a single bit error, such an error may be detected but cannot be corrected. In a SECDED protected tag array, single bit errors can be corrected while double bit errors can be detected but not corrected. For example, a tag value “1111111” may be written to a particular location in the tag array for a cache line L, but due to certain factors (such as ambient radiation) one or more of the bits stored at that location may be changed. After such a change, the tag array location may incorrectly store the value “1011111” as the tag for cache line L. In a parity protected tag array, when this tag is read as “1011111,” this may be flagged as an error. In an SECDED protected tag cache, by contrast, the value “1011111” for the same tag may be corrected to “1111111” when read, while the value “0011111” may be flagged as an error.

In some caches with such error detection, a cache access that results in a “miss” (because the requested data is not found in that cache) may also result in the detection of an tag error in one of the tag array locations in the set of locations that were accessed. If this error cannot be corrected using the error correction bits, and that uncorrectable error is detected for a cache line having a MESI state of E or S, the cache can treat this as a cache miss and invalidate the erroneous line. In this case, the erroneous line can be discarded because it is not being used (i.e., it has not been modified). If the same access resulted in a miss and the MESI state of the error line is M (or P), however, some caches may treat the error as fatal in that the cache may not be able to properly service the line, and this may result in a reset condition. In this case, because the modified cache line may contain an error, it is considered lost.

### BRIEF DESCRIPTION OF THE DRAWINGS

FIG. 1 is a block diagram of a system with a cache hierarchy and an error handler in accordance with an embodiment of the present invention.

FIG. 2 is a block diagram that illustrates tags stored in a lower level cache and upper level cache in accordance with an embodiment of the present invention.

FIG. 3 is a block diagram that illustrates an example of a lower level cache tag that may be corrected in accordance with an embodiment of the present invention.

FIGS. 4-5 are flow diagrams for a method of correcting an error in a stored tag in accordance with an embodiment of the present invention.

FIG. 6 is a block diagram of a further embodiment of a system with a cache hierarchy and an error handler in accordance with an embodiment of the present invention.

### DETAILED DESCRIPTION

The devices and methods described below may be used to correct errors in information stored in a cache memory array. For example, embodiments of a system as described below may use redundant information that is stored at one level of a cache hierarchy to correct an error that is detected in a tag stored at a different level of that cache hierarchy. It will be appreciated that modifications and variations of the examples described are covered by the teachings provided below and are within the purview of the appended claims.

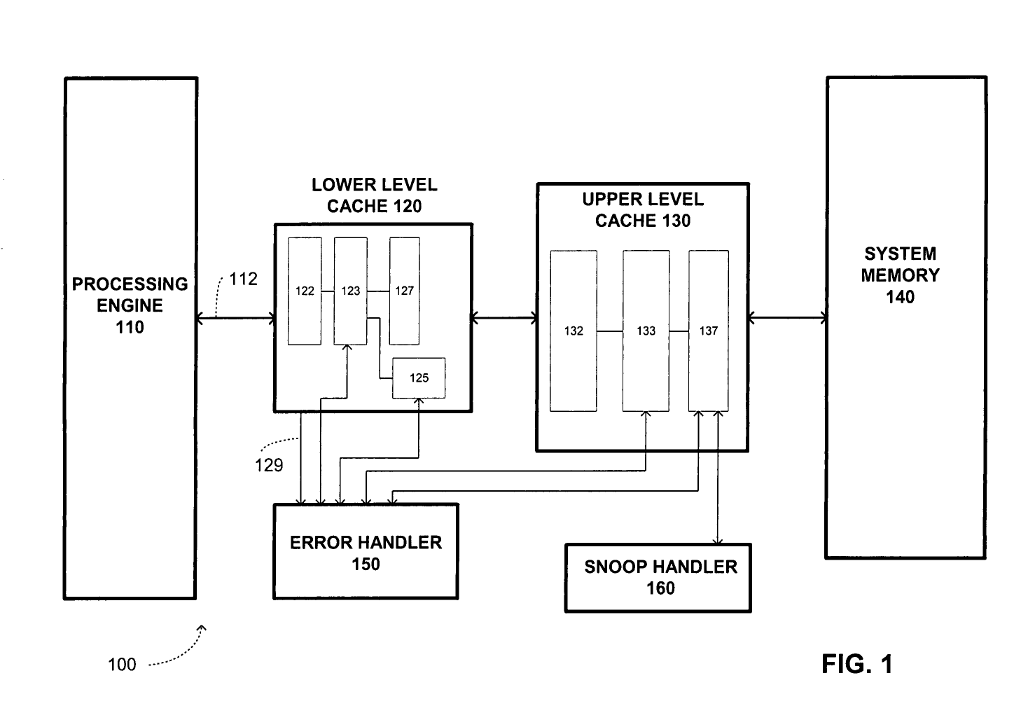

FIG. 1 is a block diagram of a system 100 with a cache hierarchy and an error handler in accordance with an embodiment of the present invention. As shown in FIG. 1, system 100 includes a processing engine 110 that is coupled to a lower level cache 120 by a connection 112. In addition, lower level cache 110 may be coupled to an upper level cache 130, and upper level cache 130 may be coupled to a system memory 140. The processing engine 110 may be, for example, the part of a computer processor that processes software instructions. In an embodiment, lower level cache 120 may be a level one cache, and processing engine 110 and lower level cache 120 may be part of a central processing unit (CPU) such as a Pentium® processor from Intel Corporation of Santa Clara, Calif. Lower level cache 120 and an upper level cache 130 may be any type of memories that cache information, such as data or instructions, and may be comprised of for example Random Access Memory (RAM), Static Random Access Memory (SRAM), or some combination of these or any other types of memory. System memory 140 may also be any type of memory, such as for example a RAM.

In operation, processing engine 110 may send to an input in lower level cache 120 a request for data that is stored at an address in system memory 140, which may identified by a tag and a set. Lower level cache 120 may return the requested data if that data is stored in lower level cache 120. If the data is not being cached in lower level cache 120 (i.e., there is a cache miss), it may forward the data request to upper level cache 130, which may return the requested data (if there is a cache hit) or may forward the request on to system memory 140 (if there is a cache miss).

In an embodiment, lower level cache 120 may comprise a data array 122, a tag array 123, and a state array 127. Similarly, upper level cache 130 may comprise a data array 132, a tag array 133, and a state array 137. Tag array 123 may store a plurality of lower level tags to identify a location in lower level cache 120 of requested data. Tag array 123 may contain logic to determine if any of these lower level tags match the received tag (i.e., the tag identified by the received address). Similarly, tag array 133 may store a plurality of upper level tags to identify a location in upper level cache 130 of the requested data if that data was not found in the lower level cache (i.e., if the lower level tags in tag array 122 do not identify a location of the requested data in lower level cache 120) and may contain tag matching logic.

In an embodiment, lower level cache 120 may further comprise a state array 127 which may contain a plurality of memory locations to store cache coherency states for the cache lines, such as information indicating whether an individual cache line in lower level cache 120 is in a state selected from the group consisting of modified, exclusive, shared, or invalid. Similarly, upper level cache 130 may further comprise a state array 137 which may contain a plurality of memory locations to store cache coherency states for the cache lines, such as information that indicates whether an individual cache line in upper level cache 130 is in a state selected from the group consisting of modified, exclusive, shared, or invalid. In a further embodiment, the memory locations in state array 137 may also indicate whether an individual cache line in the upper level cache is also present in the lower level cache. For example, for each cache line in upper level cache 130, state array 137 may store one of the states M, E, S, I, M′, S′, or E′, where M and M′ indicate that the cache line in upper level cache 130 corresponding to the state array entry is in the modified state, E and E′ indicate that that cache line is in the exclusive state, S and S′ indicate that that cache line is in the shared state, and I indicates that that cache line is in the invalid state. In addition, in this example, the states M, E, and S may also indicate that the corresponding cache line in upper level cache 130 is also present in lower level cache 120 (i.e., it is being cached by both caches), while the states M′, S′, and E′ may indicate that the corresponding cache line in upper level cache 130 is not present in lower level cache 120.

In addition, lower level cache 120 may also includes a hardware error detection element 125 to detect and indicate whether one of the lower level tags stored in lower level tag array 123 has an n bit error, where n may be some number that depends upon the error detection range of the error detection element. In an embodiment, for example, error detection element 125 may provide parity protection and thus detect 1 bit errors. In another embodiment, error detection element 125 may provide SECDED protection and may correct 1 bit errors and detect 2 bit errors. In an embodiment, error detection element 125 may detect an error in any of the tags stored in the lower level tag array that are within a set identified by the data request.

As shown in FIG. 1, system 100 may include an error handler 150 and a snoop handler 160. As shown, error handler 150 may be coupled to tag array 123, error detection element 125, tag array 133, and state array 137. Snoop handler 160 may be coupled to state array 137. In an embodiment, and as further discussed below, error handler 150 may derive a correct value for a stored lower level tag that has an n bit error from one of the upper level tags stored in the upper level tag array. In an embodiment, error handler 150 may determine whether a tag stored in upper level tag array 133 corresponds to a tag stored in lower level tag array 123 that has an error, as detected by error detection element 125, and if so identify that upper level tag as the corresponding tag. Such identification may be based upon a comparison of the upper level tag and lower level tag for each cache line present in both the upper level cache and lower level cache and an elimination of any upper level tags that have a match in the lower level tag array. Error handler 150 may then derive a correct value for a tag in lower level tag array 123 from the identified upper level tag. In an embodiment, and as further discussed below, error handler 150 may determine that an unrecoverable error has occurred if the lower level cache 120 has modified the cache line that has an error and the error detection element 125 has an error detection range n (that is, can detect up to n bit errors) which is greater than or equal to the number of bits that are different between a lower level tag for the requested data and the error line. In this regard, lower level cache 120 may include an element to indicate whether there are any tags in the plurality of stored tags that have less than n bits that are different than corresponding bits in the received tag, and lower level cache 120 may include a connection line 129 to provide such information to error handler 150. For example, where SECDED protection is used, line 129 may indicate whether there are more than two bits different between the error line and the received tag.

Snoop handler 160 may prevent a snoop to the lower level cache if information stored in the plurality of memory locations indicates that the cache line to be snooped is not present in the lower level cache. For example, if a snoop is received for a cache line, snoop handler 160 may determine from the information in state array 137 that that cache line is not present in lower level cache 120 and may indicate that a response to the snoop request may be generated without having to snoop lower level cache 120 for that cache line. Error handler 150 and/or snoop handler 160 may be implemented in hardware circuits, firmware, software, or some combination of these. In an embodiment, processing engine 110, lower level cache 120, error handler 150 and/or snoop handler 160 may be part of the same processor microchip.

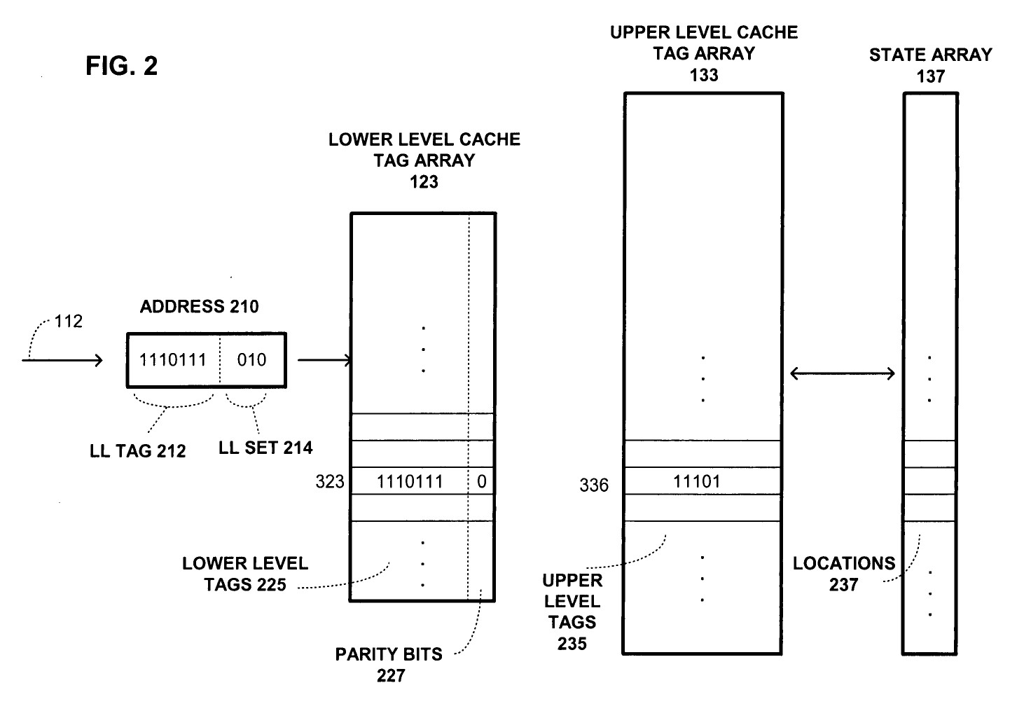

FIG. 2 is a block diagram that illustrates tags stored in a lower level cache and upper level cache in accordance with an embodiment of the present invention. FIG. 2 shows a part of system 100 of FIG. 1. In particular, FIG. 2 shows connector 112, lower level cache tag array 123, upper level cache tag array 133, and upper level cache state array 137 of FIG. 1. In addition, FIG. 2 shows an example of an address 210 for which processing engine 110 may be storing data or requesting data from lower level cache 120. As shown, address 210 comprises a group of bits which may be viewed as a lower level tag 212, which in this example contains the value 1110111, and a lower level set 214, which in this example contains the value 010. In a typical system, these values may be larger, and for example the tag may comprise 30 bits. The lower level set value 010 may identify one of eight different sets in lower level cache 120, and the lower level tag value 1110111 may be used to match against a tag value in tag array 123 as per conventional practices. In embodiments, the address may also contain offset bits, which are not shown in FIG. 2. Because other caches (such as upper level cache 130) may have a different arrangement than lower level cache 120, the address 210 may also be viewed as a different size tag and set for use by a different cache. For example, if the upper level cache is four times the size of the lower level cache, the upper level tag may be 11101 and the upper level set number may be 11010. In this example, increasing set size four times implies moving two least significant lower level tag bits to the upper level set bits. Thus, a line found in set 010 of the lower level cache can be found in one of four sets (11010,10010, 01010, 00010) in the upper level cache.

As shown in FIG. 2, lower level tag array 123 contains a plurality of lower level tags 225, upper level tag array 133 contains a plurality of upper level tags 235, and state array 137 contains a plurality of locations 237 each of which corresponds to a cache line in upper level cache 130. Lower level tags 225 and upper level tags 235 each may comprise a plurality of bits. For example, the value 1110111 for lower level tag 212 in address 210 may be stored as lower level tag 323 in tag array 123. Similarly, an upper level tag may be derived from address 210 and stored in upper level tag array 133 as upper level tag 336. In the example shown, upper level tag 336 has the value 11101, which contains the same first five bits as lower level tag 326. In the embodiment shown, lower level cache tag array 123 also stores a plurality of parity bits 227, each of which may be used to check the parity of a tag stored in tag array 123. In the example shown, the value 0 is stored as the parity bit for tag 323. In other embodiments, other types of error protection may be used.

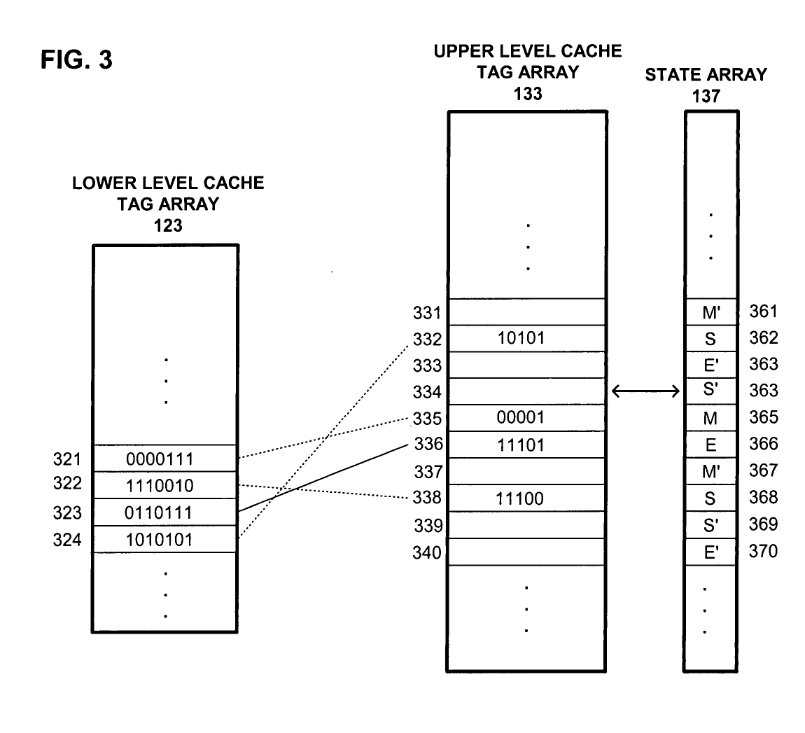

FIG. 3 is a block diagram that illustrates an example of a lower level cache tag 323 that may be corrected in accordance with an embodiment of the present invention. FIG. 3 shows lower level cache tag array 123, upper level cache tag array 133, and upper level cache state array 137 as in FIGS. 1 and 2. FIG. 3 also shows tag 323 in lower level tag array 123 and tag 336 in upper level tag array 133 as in FIG. 2. In addition, FIG. 3 also shows tags 321, 322 and 324 in lower level tag array 123, tags 331-335 and 337-340 in upper level tag array 133, and locations 361-370 in state array 137. Each of locations 361-370 is shown storing a sample state value. In this example, the state for the cache entries corresponding to locations 362, 365, 366, and 368 (S, M, E and S, respectively) indicate that lower level cache 120 also stores the corresponding cache line that is present in upper level cache 130. For the purposes of illustration, FIG. 3 shows certain sample tag values stored in tags 332, 335, 336 and 338 in upper level cache tag array 133 because the corresponding cache lines are also stored in lower level cache 120 (as indicated by state array 137). Tags 321-324 in tag array 123 are also shown storing sample tag values. Note that although in FIG. 3 the tag value for tag 336 in upper level cache tag array 123 is the same as shown in FIG. 2, that tag value for tag 323 in lower level tag array 123 in FIG. 3 is 1 bit different than the value for that tag shown in FIG. 2. This 1 bit change (in the first bit value) represents a 1 bit error that may have occurred in the value stored in tag 323. Finally, FIG. 3 also illustrates that tag 321 and tag 335 may correspond to the same cache line as it is stored in both lower level cache 120 and upper level cache 130, that tag 322 and tag 338 may correspond to the same cache line, that tag 323 and tag 336 may correspond to the same cache line, and that tag 324 and tag 332 may correspond to the same cache line.

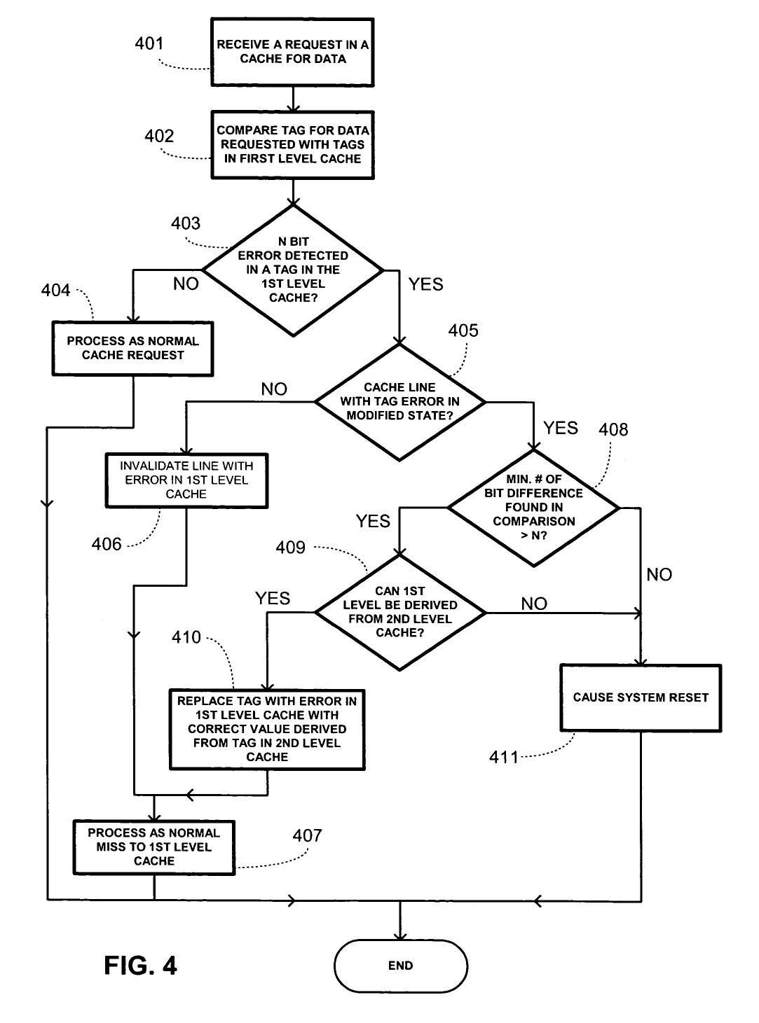

FIG. 4 is a flow diagram for a method of correcting an error in a stored tag in accordance with an embodiment of the present invention. This method may be practiced with, for example, the systems shown in FIGS. 1-3. According to this method, a cache receives a request for data that is identified by an address (401). For example, processing engine 110 may send a request to read data to lower level cache 120, and this request may specify an address (such as address 210) where the data is stored in the system memory. This cache may compare a tag derived from the received address with a plurality of tags, such as lower level tags 225, that are stored in a tag array a lower level cache, such as tag array 123 (402). The plurality of tags may be identified by a set derived from the received address, such as set 214. The cache may determine if any of the tags stored in the tag array that were compared with the received tags have an error (403). For example, error detection element 125 may determine if any of the lower level tags 225 that were accessed in tag array 123 had a 1 bit error. In other embodiments, the error detection element may have a larger range of errors that it can detect, and may be able to detect up to n bits of error. If no such errors were found, the request may be processed as a normal cache request (404). The cache may return the request data, if there is a cache hit, or may forward the request to another cache or to a system memory, if there is a cache miss.

If an error is found in one of the tags, the cache may determine if the line in the cache corresponding to this data is in the modified state (or is pending modification) (405). For example, assuming that parity protection is being employed, and a 1 bit errors can be detected but not corrected, error detection element 125 may determine that tag 323 of tag array 123 has a 1 bit error. If so, error handler 150 may determine from state array 127 whether the cache line in lower level cache 120 that corresponds to tag 323 is in the modified state. If this cache line was not modified, then the cache line may be invalidated (406) and the request may be processed as a normal miss to the cache (407). In other embodiments, the cache may first try to correct the error, as discussed below, before determining if the cache line is in the modified state.

It may then be determined whether the error can be derived from second level tag array (409). If so, the system may replace the tag that has the error with a tag from a higher level cache (410) and may process the request as a normal cache miss (407). For example, error handler 150 may derive the correct value from tag 336 (which in this example corresponds to the same cache line) and replace the value in tag 323 with the correct value. In an embodiment, the system may only attempt to correct the error if it can be processed as a normal cache miss (408), and if not may cause a system reset (411). In such an embodiment, the system may determine that the request can be processed as a normal miss if the number of bits that are different between the tag derived from the received address and the tag in the lower level cache tag array with the error is greater than the number of bit errors that may be detected by the error detection element. In other words, the error handler may determine whether the error line has at least n+1 bits that are different than corresponding bits in the tag identified by the data request, where n is the maximum size of an error that may be detected. For example, assume that error detection element 125 is able to detect up to a 2 bit error (i.e., n=2). Error handler 150 may determine that where such a 2 bit error is detected in a tag (such as tag 335), the cache request cannot be processed normally if the difference between the tag 212 from the received address 210 and that tag 325 is less than three bits. In this case, if it is possible that the tag with the 2 bit error may have actually been a hit if the value were correct.

In an alternative embodiment, for example where error handler 150 is embodied in hardware, the error handler may be able to correct an error in a tag line even if the difference between the received tag and the error line is less than or equal to the error detection range. In this case, when such an error is detected, the error handler may block the read and any other access to the line and then correct the error as discussed herein.

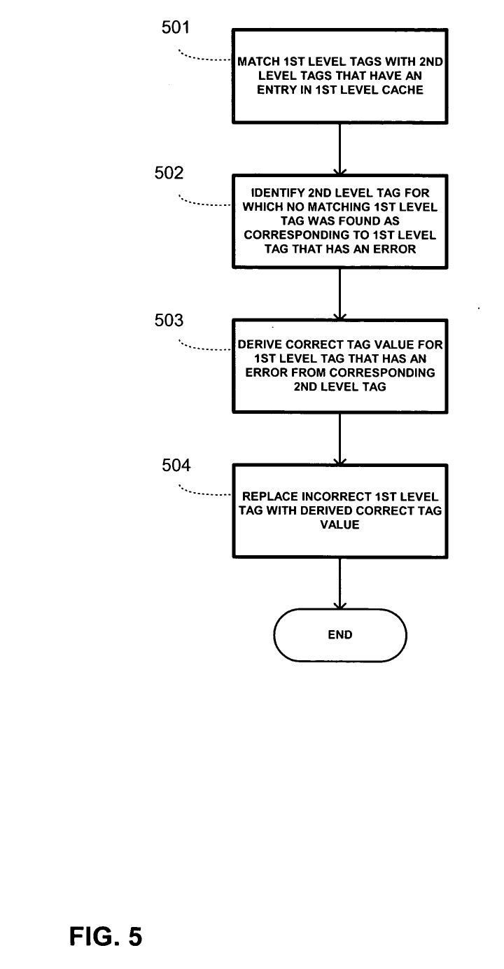

In an embodiment, it may be determined whether any cache lines in the lower level cache that are identified by the set derived from the received address are not also present in the upper level cache (409). If so, the tag with an error may be replaced with the correct value (410), using for example the method described below with reference to FIG. 5. If not, the system may determine that the error cannot be corrected and may initialize a system reset. For example, error handler 150 may determine based on state array 137 that each of the cache lines in the set identified in address 210 that are present in upper level cache 130 are also present in lower level cache 120. In embodiments, the upper level cache knows when a line in present or absent in the lower level cache because the upper level cache may track when a lower level cache allocates a line as the upper level cache services the miss associated with that allocation. In addition, the lower level cache may signal the upper level cache whenever the upper level cache victimizes a line from the lower level cache.

In an alternative embodiment where a retirement queue is used for speculative processing, after a load or store request causes an error to a line that is modified or pending modification, and the difference between the received tag and the error line is less than or equal to the error detection range, the request may be squashed, with all earlier operations retired, and error handler 150 may be used to correct the error in the tag array. After the error is corrected, the request may then be reissued.

FIG. 5 is a flow diagram for a method of deriving a correct tag value and using it as a replacement for a tag with an error in accordance with an embodiment of the present invention. The method described by FIG. 5 may be used, for example, in box 410 of FIG. 4. According to this method, the error handler may identify a stored upper level tag that corresponds to the stored lower level tag that has an error based upon a comparison of the stored upper level tag and stored lower level tag for each cache line present in both the upper level cache and lower level cache, eliminate any upper level tags that have a match in the lower level tag array, and derive the correct value for the identified stored lower level tag that has an error from the identified corresponding upper level tag.

First, an attempt may be made to match each one of a plurality of tags in the upper level cache tag array that have a corresponding cache line in the lower level cache with one of the tags in the lower level tag array that are identified by the set(s) derived from the received address (501). For example, error handler 150 may use the values in state array 137 to determine that the only cache lines in the corresponding sets of upper level cache 130 which are also present in lower level cache 120 are those that correspond to tag 332, tag 335, tag 336, and tag 338. Error handler 150 may then attempt to match the values of each of these tags against one of the lower level tags in tag array 123 that are identified by the set 214, which for example may be tags 321-324. For these purposes, a lower level tag may be considered to match an upper level tag even though they are only partly the same, for example because the tags are different sizes. Using the sample values shown in FIG. 3, error handler 150 may find that tag 321 matches tag 335 because the derived address of tag 335 is the same as the derived address of tag 321. Similarly, error handler 150 may find that tag 322 matches tag 338 and that tag 324 matches 332.

After this match is attempted, a tag in the upper level tag array for which there is no matching lower level tag may then be identified as corresponding to the tag stored in the upper level cache tag array that has an error (502). Continuing the example discussed above, error handler 150 may determine that tag 336 is the only entry in tag array 133 for which the cache line is present in cache 120 but for which a match is not found. Thus, error handler 150 may determine that tag 336 corresponds to tag 323, which for example may have a 1 bit error. The correct value for the tag may then be derived from the identified upper level tag (503). For example the value 11101 may be derived from the value stored as tag 336. Lastly, this correct value may replace the lower level cache tag that has an error (504). In the example above, the value 1110111 derived from tag 336 (and using corresponding set bits) may be stored in tag 323. In this way, the error in tag 323 has been corrected.

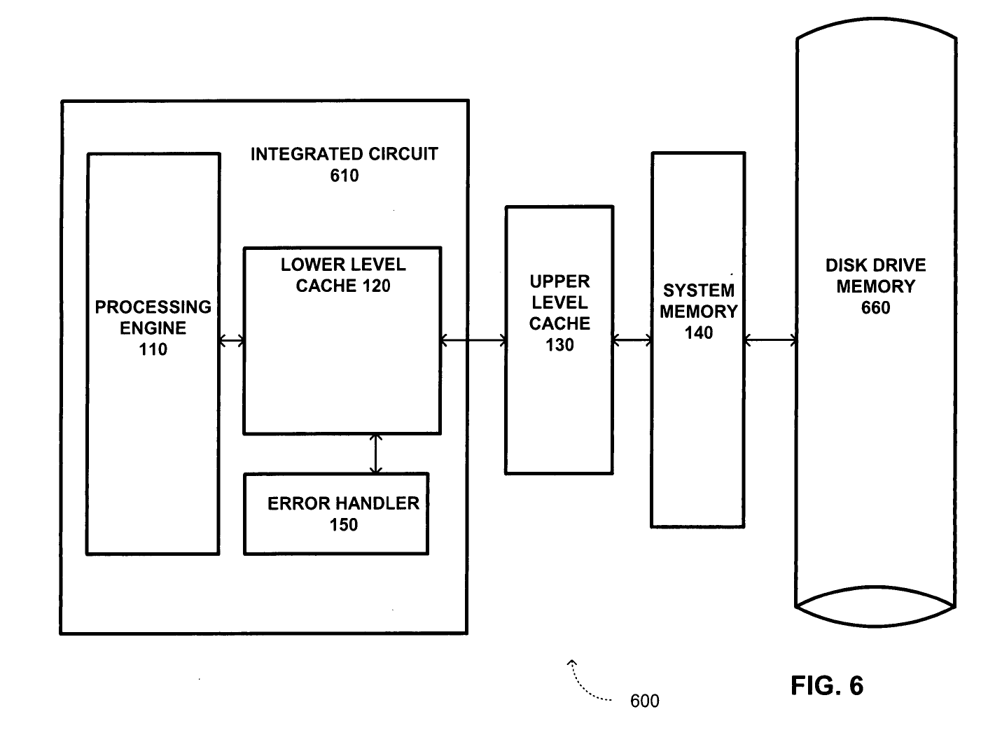

FIG. 6 is a block diagram of a further embodiment of a system with a cache hierarchy and an error handler in accordance with an embodiment of the present invention. FIG. 6 shows a system 600 that contains a processing engine 110, lower level cache 120, upper level cache 130, system memory 140 and error handler 150 as in FIGS. 1-3. For example, lower level cache 120 may be an L1 cache, upper level cache 130 may be a level two (“L2”) cache, and system memory 140 may be a system RAM. System 600 also includes a disk drive memory 660. As discussed above, system memory 140 may receive a request for data if that data is not found in the upper level cache 130 or lower level cache 140. If that data is also not found in the system memory 140, the request for the data may be send to disk drive memory 660, which may service the request. FIG. 6 also shows that processing engine 110, lower level cache 120, and error handler 150 as part of an integrated circuit 610, such as for example a microprocessor chip.

According to embodiments as discussed above, errors in information stored in a cache memory may be corrected. It will be appreciated that modifications and variations of the embodiments discussed above are covered by the teachings provided and are within the purview of the appended claims.

What is claimed is:

1. A system comprising:
a lower level cache tag array to store a plurality of lower level tags to identify a location in a lower level cache of requested data;
an error detection element to detect that one of the lower level tags stored in the lower level tag array has an error;
an upper level cache tag array to store a plurality of upper level tags to identify a location in an upper level cache of the requested data if the lower level tags do not identify a location of the requested data in the lower level cache; and
an error handler to derive a correct value for the stored lower level tag that has an error from one of the upper level tags stored in the upper level tag array.

2. The system of claim 1, wherein the system further comprises a plurality of memory locations to store information that indicates whether an individual cache line in the upper level cache is also present in the lower level cache.

3. The system of claim 2, wherein the plurality of memory locations is a state array, and which the stored information also indicates whether an individual cache line in the upper level cache is in a state selected from the group consisting of modified, exclusive, shared, or invalid.

4. The system of claim 2, wherein the system further comprises a snoop handler to prevent a snoop to the lower level cache if information stored in the plurality of memory locations indicates that the cache line to be snooped is not present in the lower level cache.

5. The system of claim 2, wherein the error handler is to identify a stored upper level tag as corresponding to the stored lower level tag that has an error based upon a comparison of the upper level tag and lower level tag for cache lines present in both the upper level cache and lower level cache and an elimination of any such upper level tags that have a match in the lower level tag array.

6. The system of claim 5, wherein the error handler is to derive the correct value for the stored lower level tag that has an error from the identified corresponding upper level tag.

7. The system of claim 2, wherein the error handler is to determine that an unrecoverable error has occurred if the lower level cache has modified the cache line that is identified by the stored lower level tag that has an error and the error detection element has an error detection range that is greater than or equal to the number of bits that are different between a lower level tag for the requested data and the stored lower level tag that has an error.

8. A system comprising:
a lower level cache memory, the lower level cache memory comprising:
an input to receive a request for data identified by a tag and a set;
a lower level tag array to store a plurality of lower level tags and to determine if any of these lower level tags match the received tag; and
an error detection element to detect an n bit error in one of the lower level tags stored in the lower level tag array in the set identified by the data request, wherein n is a predefined number; and
an upper level cache memory to receive a request for the data if that data was not found in the lower level cache, the upper level cache memory comprising an upper level tag array to store a plurality of upper level tags; and
an error handler to derive a correct value for the stored lower level tag that has an n bit error from one of the upper level tags stored in the upper level tag array.

9. The system of claim 8, wherein the error handler is to determine whether the stored lower level tag that has an n bit error has at least n+1 bits that are different than corresponding bits in the tag identified by the data request.

10. The system of claim 8, wherein the error handler is to determine that the system can recover from an n bit error detected in a lower level tag if the error line has greater than n bits that are different than corresponding bits in the tag identified by the data request.

11. The system of claim 8, wherein the upper level cache memory further comprises a state array to store values indicating for individuals cache lines in the upper level cache memory both a coherence state for the individual cache line and whether the individual cache line is also present in the lower level cache memory.

12. The system of claim 11, wherein the error handler is to identify a stored upper level tag that corresponds to the stored lower level tag that has an error based upon a comparison of the stored upper level tag and stored lower level tag for the cache line present in both the upper level cache and lower level cache and an elimination of any such upper level tags that have a match in the lower level tag array.

13. The system of claim 12, wherein the error handler is to derive the correct value for the identified stored lower level tag that has an error from the identified corresponding upper level tag.

14. A system comprising:
an input to receive a request to provide data for an address comprising a tag and a set, wherein the tag and set each comprise a plurality of bits;
a first tag array to store a plurality of tags and compare the received tag against a plurality of stored tags identified by the received set, wherein the stored tags each comprise a plurality of bits;
a first output to indicate for a received address whether there are any tags in said plurality of stored tags that have an n bit error, wherein n is a predefined number; and
a second output to indicate whether there are any tags in said plurality of stored tags that have less than or equal to n bits that are different than corresponding bits in the received tag.

15. The cache array of claim 14, further comprising:
an error handler to cause the received request to be processed as a normal cache miss if an n bit error was detected in a tag in said plurality of tags and if that tag has more than n bits that are different than corresponding bits in the received tag.

16. The cache array of claim 14, further comprising:
a second tag array to store a plurality of a plurality of tags; and
an error handler to derive a correct value for the tag in the first tag array having an n bit error from one of the tags in the second tag array if the second tag array contains a tag that corresponds to the tag in the first tag array having an n bit error.

17. The cache array of claim 16, wherein the system further comprises a plurality of memory locations to indicate for each tag in the second tag array whether the first tag array contains a corresponding entry, and wherein the error handler is to determine that a particular tag in the second tag array corresponds to the erroneous tag in the first tag array if one of the plurality of memory locations indicate that the particular tag has a corresponding tag in the first tag array and if the error handler is unable to find an entry in the first tag array that matches the particular tag.

18. The cache array of claim 17, wherein the plurality of memory locations also store a cache coherency state for a corresponding cache line.

19. A system comprising:
a processing engine to send a data request;
a first cache memory to receive the data request, the first cache memory comprising a first tag array to store a plurality of first tags and an error detection element to detect that one of the stored first tags has an error;
a second cache memory to receive a request for said data if that data is not found in the first cache memory, the second cache memory comprising a second tag array to store a plurality of second tags; and
an error handler to derive a correct value for the stored first tag that has an error from one of the second tags stored in the second tag array.

20. The system of claim 19, further comprising:
a system memory to receive a request for said data if that data is not found in the first cache memory or second cache memory; and
a disk drive memory to receive a request for said data if that data is not found in the first cache memory, second cache memory, or system memory.

21. The system of claim 19, wherein the processor and first cache memory are part of a single integrated circuit chip.

22. A method comprising:
receiving a request in a cache for data that is identified by an address;
comparing a tag derived from the received address with a plurality of tags stored in a tag array of a first level cache, wherein the plurality of tags are identified by a set derived from the received address;
detecting that one of the plurality of tags stored in the first level cache tag array has an n bit error, wherein n is a predetermined number; and
determining whether the detected error can be corrected and, if so, replacing the tag stored in first level cache that has an error with a correct tag value derived from a tag stored in a tag array for a upper level cache.

23. The method of claim 22, wherein the method further comprises determining whether the request can be processed as a normal miss in the first level cache.

24. The method of claim 23, wherein it is determined that the request can be processed as a normal miss in the first level cache if the corresponding cache line with error in the first level cache is in the modified state and has less than n+1 bits that are different than corresponding bits in the derived tag.

25. The method of claim 22, wherein it is determined that an error cannot be corrected if any cache lines in the first level cache identified by the set derived from the received address are not also present in the second level cache.

26. The method of claim 25, wherein deriving a correct value for the tag stored in the first level cache tag array that has an error comprises:
attempting to match each one of a plurality of tags in the second level cache tag array that have a corresponding cache line in the first level cache with one of the tags in the first level tag array that are identified by the set derived from the received address; and
identifying a tag in the second level tag array for which a match was not found as corresponding to the tag stored in the first level cache tag array has an error; and
deriving a correct value for the tag stored in the first level cache tag array that has an error from the identified corresponding tag in the second level tag array.
